(19) United States
(12) Patent Application Publication
(10) Pub. No.: US 2022/0164858 A1
(43) Pub. Date: May 26, 2022

(54) Order Routing and Redirecting for Fulfillment Processing

(71) Applicant: NCR Corporation, Atlanta, GA (US)

(72) Inventor: Sanjeev Kumar Singh, Johns Creek, GA (US)

(21) Appl. No.: 17/102,974

(22) Filed: Nov. 24, 2020

(51) Int. Cl. G06Q 30/06; G06Q 10/06; G06Q 30/02; G06Q 10/08; G06Q 50/12; G06N 20/00; G06N 5/04

(52) U.S. Cl. CPC G06Q 30/0635; G06Q 30/0639; G06Q 30/0605; G06Q 10/06315; G06Q 10/06312; G06N 5/04; G06Q 30/0205; G06Q 10/087; G06Q 10/0836; G06Q 50/12; G06N 20/00; G06Q 10/0639

(57) ABSTRACT

Order details for an order is evaluated based on real-time data associated with establishments that can satisfy the order, location data, traffic conditions, estimated order preparation times, and available delivery personnel (when the order is associated with a delivery). An optimal establishment that can fulfill the order is selected and the order with the order details is placed with the optimal establishment. In an embodiment, the real-time data continues to be evaluated after the order is placed, and when conditions warrant the order is redirected to a new optimal establishment for fulfillment.

### BACKGROUND

With the COVID19 pandemic, demand for online ordering in food service industry for pickup and delivery has increased significantly compared to dining service. There is now an even greater need for efficiency in handling of orders and timely delivery to customers.

Current ordering systems are mostly fixed based on customer selection and does not provide optimal experience to the customer. Customer often makes selection of a site based on proximity to their location or past order history but do not know if another site can provide faster service. Customers often can also encounter issues with availability of a specific menu item at a site and not know that it may be available at another site. Even when a customer has made selection of a specific site, certain issues can come up subsequently that can ruin the plan for a perfect meal as the order may be delayed due to traffic, delivery personnel availability, unforeseen circumstances at the selected site, etc.

With present solutions, the best that a customer can do is check order processing times at multiple sites and research the traffic conditions to select an optimal ordering site. However, this is a manual activity and can be time consuming for customers. Similarly, a customer may periodically check an order's progress and if a change is needed, the customer can initiate the change manually. Yet, this too is inconvenient for a customer as he/she needs to manually identify a different site for the order, cancel the original order from the original site, and then re-order from the new site.

Thus, current options available to customers are not desirable and are limited. Furthermore, the COVID19 pandemic has exacerbated the inefficiencies associated with online ordering for delivery and pickup by customers. This is at a time when the only options available to customers may be delivery or pickup, since in many locales dine-in options are no longer available.

### SUMMARY

In various embodiments, methods and a system for order routing and redirection for fulfillment processing are provided.

According to an embodiment, a method for order routing and redirection for fulfillment processing is presented. Order details associated with an order that has not been placed are received. Potential establishments are identified that can satisfy the order details based on location data. Real-time order preparation times are obtained for the order details from the potential establishments. An optimal establishment is selected from the potential establishments based at least in part on the real-time order preparation times and the order is placed with the optimal establishment as an online order through an online service.

### BRIEF DESCRIPTION OF THE DRAWINGS

FIG. 1 is a diagram of a system for order routing and redirection for fulfillment processing, according to an example embodiment.

FIG. 2 is a diagram of a method for order routing and redirection for fulfillment processing, according to an example embodiment.

FIG. 3is a diagram of another method for order routing and redirection for fulfillment processing, according to an example embodiment.

### DETAILED DESCRIPTION

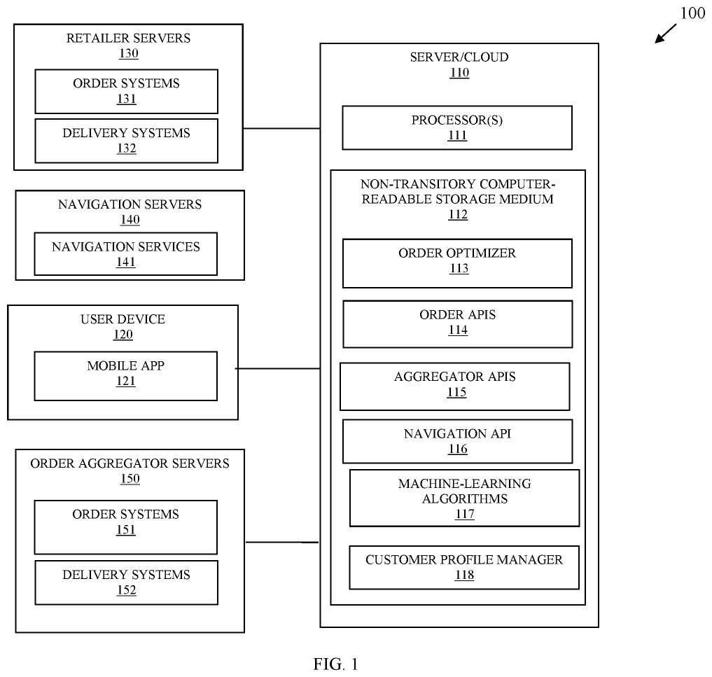

FIG. 1 is a diagram of a system 100 for order routing and redirection for fulfillment processing, according to an example embodiment. It is to be noted that the components are shown schematically in greatly simplified form, with only those components relevant to understanding of the embodiments being illustrated.

Furthermore, the various components (that are identified in the FIG. 1) are illustrated and the arrangement of the components is presented for purposes of illustration only. It is to be noted that other arrangements with more or with less components are possible without departing from the teachings of order routing and redirection for fulfillment processing, presented herein and below.

As used herein and below, the terms “user,” “consumer,” “user,” and “customer” may be used interchangeably and synonymously. The terms refer to an individual placing an order for pickup or delivery.

It is noted that the term “establishment” as used herein refers to a specific restaurant location or a specific store. The establishment itself may be associated with a chain or a franchise and include a single online ordering service that handles orders for all of its stores. The establishment may also be associated with a non-chain restaurant location or a non-chain store having its own independent online ordering service. The establishment may also be associated with a specific store that lacks any online ordering service, but handles orders placed manually by phone from an order aggregator on behalf of customers (this phone order may be transparent to the customer, since the customer is only aware of placing the online order through the aggregator service).

As will be demonstrated more clearly herein and below, system 100 permits users to perform online orders for pickup or delivery. A variety of real-time data is evaluated for establishments, delivery personnel, and traffic conditions in view of the ordered items for a given order. An optimal establishment and delivery resource are selected for fulfilling the order and the order is placed with that establishment. The real-time data continues to be evaluated after the placed order with the establishment, and when conditions warrant, the order may be redirected to a different establishment for fulfillment.

System 100 includes a server/cloud 110, one or more user devices 120, one or more retailer servers 130, one or more navigation servers 140, and one or more aggregator servers 150.

Server/cloud 110 comprises at least one processor 111 and a non-transitory computer-readable storage medium 112. Medium 112 comprises executable instructions representing an order optimizer 113, order APIs 114, aggregator APIs 115, a navigation API 116, a customer profile manager 117, and one or more machine-learning algorithms (MLAs) 118. Executable instructions when executed by processor 111 from medium 112 cause processor 111 to perform the processing discussed herein and below with respect to 113-118.

User device 120 comprises a processor and a non-transitory computer-readable storage medium. The medium comprising executable instructions for a mobile app (app) 121. The executable instructions when executed by the processor from the medium cause the processor to perform the processing discussed herein and below with respect to app 121.

Each order server 130 comprises at least one processor and non-transitory computer-readable storage medium. The medium comprising executable instructions for an order system 131 and a delivery system 132. The executable instructions when executed by the processor from the medium cause the processor to perform the processing discussed herein and below with respect to order system 131 and delivery system 132.

Each navigation server 110 comprises at least one processor and non-transitory computer-readable storage medium. The medium comprising executable instructions for a navigation service 141. The executable instructions when executed by the processor from the medium cause the processor to perform the processing discussed herein and below with respect to navigation service 141.

Each aggregator server 150 comprises at least one processor and non-transitory computer-readable storage medium. The medium comprising executable instructions for an order system 151 and a delivery system 152. The executable instructions when executed by the processor from the medium cause the processor to perform the processing discussed herein and below with respect to order system 151 and delivery system 152.

During operation of system 100, a customer initiates an order for fulfillment in a variety of different manners. In one scenario, the customer operates device 120 and app 121 to provide order details to an order aggregator service, such as Door Dash®, Postmates®, Grub Hub®, etc. In another scenario, the customer operates device 120 and app 121 to provide order details to a specific retailer's online ordering service. In a third scenario, the customer operates device 120 and app 121 to provide order details to customized app 121 associated with system 100.

In the first and second scenarios, app 121 represents an enhanced version of a given aggregator service's app and an enhanced version of a given retailer's online order service's app. The enhanced versions are enhanced to provide user-facing options and views associated with information returned by system 100 when selecting an optimal establishment for a given order or when redirecting a placed order to a changed optimal establishment after the order was placed with an original establishment.

In the third scenario, app 121 represents a customized ordering app 121 associated with system 100 where user screens and options are provided for processing customer orders with retailers and ensuring fulfillment processing of the orders for pickup by the customers or for delivery by a delivery resource.

Additionally, the workflow associated with order and fulfillment processing of both retailers and order aggregator services are enhanced to integrate with system 100. Integration can be achieved as a front-end process within the workflows where order details are submitted by a customer, but the orders are not yet placed with a particular establishment. Workflow integration is also achieved after an order is placed with a particular establishment. This allows system 100 to select an optimal establishment for placing an order and also allows system 100 to monitor the fulfillment status of any given placed order with a specific establishment for determining whether to redirect the placed order from the specific establishment to a current optimal establishment.

App 121 reports location data for device 120 to order optimizer in real time. This allows order optimizer to determine a current location of the customer at any given point in time. A registered customer with system 100 may also have a profile managed by customer profile manager 118. A profile comprises a variety of customer-specific data, such as home address, maximum acceptable wait time for pickup, maximum acceptable wait time for delivery, preferred wait time for pickup, preferred wait time for delivery, preferred establishments, disfavored establishments, payment cards or services, etc. A customer profile may be linked to a given customer via a device identifier for user device 120, email address, phone number, registered username, etc.

When a customer places an order, an order type is determined. The type is for pickup or for delivery. For delivery, a default address is set to a customer's current location or home address, app 121 permits the customer to change the delivery location from a set default address to a user-provided delivery address. The type of order and the delivery address may be provided or obtained from order system 131 for a given retailer using order API 114 or may be provided or obtained from order system 151 of a given aggregator server 150 using aggregator API 115. When app 121 is a customized app 121 to system 100, the type of order and the delivery address is obtained directly from a customer profile and customer interactions when attempting to place an order via app 121.

Once the order type is known and the delivery address for the order, order details are obtained from the customer by either a given retailer's online ordering service, a given order aggregator's online ordering service, or via user interactions with a customized app 121 to system 100. The order details include types of food items selected by the customer for a selected establishment menu or a generic menu that spans multiple different establishments. The menus that are provided by app 121 (in any of the three above discussed scenarios—enhanced retailer mobile app 121, enhanced aggregator mobile app 121, or customized app 121 to system 100).

Order optimizer 113 collects real-time data from a variety of sources using APIs 114-116. Firstly, optimizer 113 determines available locations of establishments that can satisfy the order details and that are within a predefined zone (geographic range) of a current location of the customer when the order type is pickup or of a delivery address when the order type is delivery. Next, inventory data for availability of the order items associated with the order details are obtained from each of the locations using order APIs 114 to query order systems 131. This reduces the number of establishments to just those establishments that are within the predefined zone and that can currently satisfy the order details for the order. Next, order APIs 114 are processed to interact with order systems 131 for purposes of obtaining an order fulfillment time for the order (this may also be based on historical fulfillment times associated with the remaining establishments for a given calendar date, day of week, and time of day). Then, optimizer 113 uses order APIs 114 or aggregator APIs 115 to interact with delivery systems 131 and delivery systems 152 to identify delivery personnel and current locations of each delivery personnel when the order type is delivery. Finally, optimizer uses navigation API 116 to interact with navigation service 141 to obtain current and anticipated traffic conditions from a current location of the customer (order type is pickup) to the remaining establishments that are left to satisfy the order details or from the remaining establishments left to satisfy the order to the delivery address (order type is delivery). This real-time collected data is then analyzed to select a specific establishment as an optimal establishment for the order based on the specific establishment being the most likely to fulfill the order (pickup or delivery based on order type) for the customer from an order placement time for the order. In other words, the optimal establishment is the establishment that can have the order ready for pickup or have the order delivered to the customer the soonest when compared to the candidate establishments for which the real-time data was analyzed. The optimal establishment may also be selected by the customer from app 121 from a ranked listing of the establishments sorted from least amount of fulfillment time needed to highest fulfillment time needed.

As optimizer 113 picks optimal establishments for orders, actual fulfillment times for those orders can be maintained along with the order details, order type, location data, and real-time data that was analyzed for picking those optimal establishments. This is used to train one or more MLAs 117 to produce a ranked listing of establishments when provided new order details, location details, and the real-time data. Each establishment is scored for a given order and the scores returned highest to lowest as output by the MLAs 117. The highest score representing an establishment that has the shortest fulfillment time for a given order; the lowest score representing an establishment hat has the longest fulfillment time for a given order.

MLAs 117 develop predictive models that can analyze order details, order types, location data, and the real-time data discussed above to predict time estimates for fulfillment of orders. The model considers not only the preparation time estimated for the restaurant but also other input such as delivery/pickup time depending on traffic condition and availability of delivery personnel. The model scores each restaurant site (establishment), in a customer's delivery/pickup zone, to rank them based on estimated fulfilment time and select the site that provides shortest time for order fulfillment. The model can be trained to predict order fulfillment time and establishment ranking using past data and then can be applied in real-time when order is placed. The model may leverage existing methods for food prep time and delivery time estimation from restaurants or create new method to do such estimation enriched with real-time driving estimates based on traffic information to create a ranked list of establishments.

Once an optimal establishment is selected, the optimal establishment for placing the order is provided to order system 131 (when the online order is being directly placed with an establishment) or order system 151 (when the online order is placed through an aggregation service). The estimated fulfillment time for the order along with the optimally selected establishment name are provided to the customer through app 121.

After the order is placed, optimizer 113 continues to monitor the real-time data being collected for the establishments. At periodic intervals, optimizer 113 (can be using MLAs 117) re-ranks the establishments for an optimal establishment to handle the already placed order. A decision can be made based on a current process of the order with the establishment handling the order and the new estimated or predicted fulfillment times for the establishments as to whether to redirect the order that was already placed to a new optimal establishment for order fulfillment. This can be achieved in a number of manners.

If the initial optimal establishment was automatically selected and the order was a delivery order, the optimizer 113 can automatically change the order and send new notification to the customer via app 121.

If the initial optimal establishment was automatically selected and the order was a pickup order, the optimizer 113 can notify the customer about another recommended optimal establishment and provide an option for customer to update the ordered establishment. This can be achieved by customer clicking on a link to confirm the change within app 121.

If the initial optimal establishment was selected by the customer, the optimizer 113 can notify the customer about another recommended optimal establishment and provide an option for customer to update the ordered establishment. This can be achieved by customer clicking on a link to confirm the change within app 121.

In an embodiment, any initial placed order with an establishment may be redirected through the online order service associated with a chain or franchise of the establishment. In this case, optimizer 113 interacts with a single order system 131 to request that a placed order for a customer be redirected to a different establishment associated with the chain or franchise when the initial optimal establishment and a new optimal establishment are associated with the same chain or franchise.

In an embodiment, any initial placed order through an aggregator online service may be permitted to be canceled and re-directed to a different establishment by policy of the aggregator.

In an embodiment, depending on restaurant operator or order aggregator preference, system 100 may offer incentives to customers to opt in for recommended establishments during the initial order as well as subsequently change establishments.

In an embodiment, app 121 permits customer ordering from generic menus that are not specific to any establishment and optimizer 113 is implemented to identify a ranked list of optimal establishments for the customer to select to fulfill the customer's order for pickup or delivery.

In an embodiment, app 121 permits customer order from a specific establishment, chain, or franchise menu and processes optimizer 113 before the order is placed for the customer to determine whether to stay with the specific establishment for fulfilling the order or changing to an optimal establishment determined by optimizer 113.

In an embodiment, the customer profile includes a setting that authorizes optimizer 113 to select the establishment automatically for order details on behalf of the customer.

In an embodiment, the customer profile includes a setting that authorizes optimizer 113 to redirect an initially placed order with a first establishment to a second establishment without customer notification when the order type is delivery.

In an embodiment, app 121 is a mobile device app or a browser-based app.

In an embodiment, user device 120 is a phone, a tablet, a laptop, a desktop computer, a wearable processing device, or a voice-enabled network device (e.g., Amazon® Echo®, Google® Home®, Apple® Siri®, etc.).

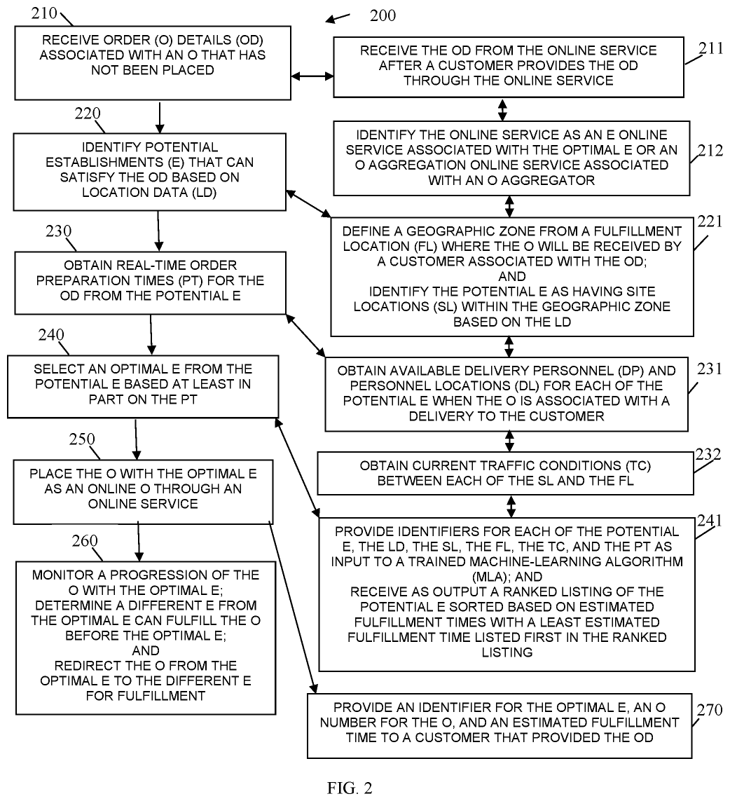

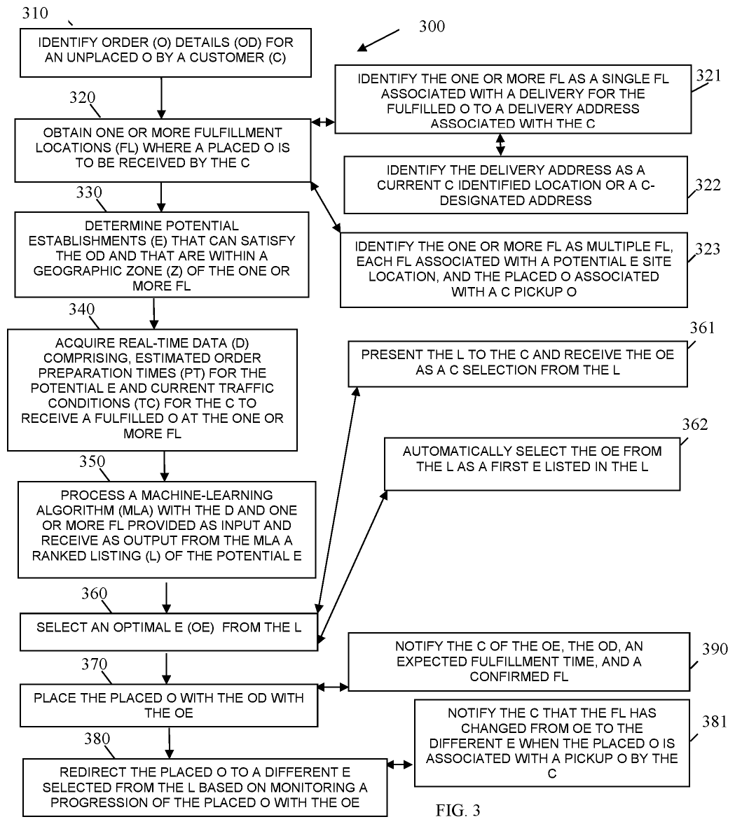

These and other embodiments are now discussed with reference to FIGS. 2-3.

FIG. 2 is a diagram of a method 200 for order routing and redirection for fulfillment processing, according to an example embodiment. The software module(s) that implements the method 200 is referred to as a “order fulfillment optimization selector.” The order fulfillment optimization selector is implemented as executable instructions programmed and residing within memory and/or a non-transitory computer-readable (processor-readable) storage medium and executed by one or more processors of a device. The processor(s) of the device that executes the order fulfillment optimization selector are specifically configured and programmed to process the order fulfillment optimization selector. The order fulfillment optimization selector may have access to one or more network connections during its processing. The network connections can be wired, wireless, or a combination of wired and wireless.

In an embodiment, the device that executes the order fulfillment optimization selector is server 110. In an embodiment, the server 120 is a cloud-based processing environment comprising a collection of physical servers cooperating as a single logical server (a cloud 110).

In an embodiment, the order fulfillment optimization selector is all or some combination of the optimizer 113, order APIs 114, aggregator APIs 115, navigation APIs 116, MLAs 117, and/or customer profile manager 118.

At 210, order fulfillment optimization selector receives order details associated with an order that has not been placed with an establishment.

In an embodiment, at 211, the order fulfillment optimization selector receives the order details from the online service (discussed at 250 below) after a customer provides the order details through the online service.

In an embodiment of 211 and at 212, the order fulfillment optimization selector identifies the online service as an establishment online service associated with the optimal establishment or an order aggregation online service associated with an order aggregator.

At 220, the order fulfillment optimization selector identifies potential establishments that can satisfy the order details based on location data.

In an embodiment of 212 and 220, at 221, the order fulfillment optimization selector defines a geographic zone from a fulfillment location where the order will be received by a customer associated with the order details. The order fulfillment optimization selector identifies the potential establishments as having site locations within the geographic zone based on the location data.

At 230, the order fulfillment optimization selector obtains real-time order preparation times for the order details from the potential establishments or for the potential establishments based on past order fulfillment metrics associated with the potential establishments.

In an embodiment of 221 and 230, at 231, the order fulfillment optimization selector obtains available delivery personnel and personnel locations for each of the potential establishments when the order is associated with a delivery to the customer (fulfillment location is a customer-defined address).

In an embodiment of 231 and at 232, the order fulfillment optimization selector obtains current traffic conditions between each of the site locations and the fulfillment location (fulfillment location is a customer defined address).

At 240, the order fulfillment optimization selector selects an optimal establishment from the potential establishments based at least in part on the real-time order preparation times.

In an embodiment of 232 and 240, at 241, the order fulfillment optimization selector provides identifiers for each of the potential establishments, the location data, the site locations, the fulfillment location, the traffic conditions, and the real-time order preparation times. The order fulfillment optimization selector receives as output from the trained machine-learning algorithm a ranked listing of the potential establishments sorted based on estimated fulfillment times with a least estimated fulfillment time listed first in the ranked listing.

At 250, the order fulfillment optimization selector places the order with the optimal establishment as an online order through an online service.

In an embodiment, at 260, the order fulfillment optimization selector monitors a progress of the order with the optimal establishment and determines a different establishment from the optimal establishment that can fulfill the order before the optimal establishment can fulfill the order. The order fulfillment optimization selector redirects the order from the optimal establishment to the different establishment for fulfillment.

In an embodiment, at 270, the order fulfillment optimization selector provides an identifier for the optimal establishment, an order number for the order, order details, and an estimated fulfillment time to a customer that provided the order details.

FIG. 3 is a diagram of another method 300 for order routing and redirection for fulfillment processing according to an example embodiment. The software module(s) that implements the method 300 is referred to as an “optimal establishment selection manager.” The optimal establishment selection manager is implemented as executable instructions programmed and residing within memory and/or a non-transitory computer-readable (processor-readable) storage medium and executed by one or more processors of a device. The processors that execute the optimal establishment selection manager are specifically configured and programmed to process the optimal establishment selection manager. The optimal establishment selection manager may have access to one or more network connections during its processing. The network connections can be wired, wireless, or a combination of wired and wireless.

In an embodiment, the device that execute the optimal establishment selection manager is server 110. In an embodiment, the server 120 is a cloud processing environment (cloud 110).

In an embodiment, the optimal establishment selection manager is all of, or some combination of optimizer 113, order APIs 114, aggregator APIs 115, navigation API 116, MLAs 117, customer profile manager 118, and/or the method 300.

The optimal establishment selection manager presents another and, in some ways, enhanced processing perspective of the method 200.

At 310, the optimal establishment selection manager identifies order details for an unplaced order by a customer.

At 320, the optimal establishment selection manager obtains one or more fulfillment locations where a placed order is to be received by the customer. Multiple fulfillment locations potentially exists when the order is associated with a pickup order type; a single fulfillment location exists when the order is associated with a delivery order type.

In an embodiment, at 321, the optimal establishment selection manager identifies the one or more fulfillment locations as a single fulfillment location associated with a delivery for a fulfilled order to a delivery address associated with the customer.

In an embodiment of 321 and at 322, the optimal establishment selection manager identifies the delivery address as a current customer identified location or a customer-designated address.

In an embodiment, at 323, the optimal establishment selection manager identifies the one or more fulfillment locations as multiple potential fulfillment locations, each potential fulfillment location associated with a potential establishment and the placed order is associated with a customer pickup order type.

At 330, the optimal establishment selection manager determines potential establishments that can satisfy the order details and that are within a geographic zone of the one or more fulfillment locations.

At 340, the optimal establishment selection manager acquires real-time data comprising estimated order preparation times for the potential establishments and current traffic conditions for the customer to receive a fulfilled order at the one or more fulfillment locations.

At 350, the optimal establishment selection manager processes a machine-learning algorithm with the real-time data and the one or more fulfillment locations provided as input and receives as output from the machine learning algorithm a ranked listing of the potential establishments. Each potential establishment is scored based on its estimated time to prepare and provide the order as a fulfilled order to the customer at the fulfillment location.

At 360, the optimal establishment selection manager selects an optimal establishment from the ranked listing.

In an embodiment, at 361, the optimal establishment selection manager presents the ranked listing to the customer and receives the optimal establishment as a customer-provided selection from the ranked list.

In an embodiment, at 362, the optimal establishment selection manager automatically selects the optimal establishment from the ranked list based on a highest score associated with the optimal establishment.

At 370, the optimal establishment selection manager places the placed order with the order details with the optimal establishment.

In an embodiment, at 380, the optimal establishment selection manager redirects the placed order to a different establishment selected from the ranked list based on monitoring a progression of the placed order with the optimal establishment.

In an embodiment of 380 and at 381, the optimal establishment selection manager notifies the customer that the fulfillment location has changed from the optimal establishment to the different establishment when the placed order is associated with a pickup order by the customer.

In an embodiment of 370 and at 390, notifies the customer of the optimal establishment, the order details, an expected fulfillment time, and a confirmed fulfillment location for the customer to receive the order, which is the optimal establishment's location when the placed order is a pickup order type and which is a customer-designated location when the placed order is a delivery order type.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving order details associated with an order that has not been placed;
identifying potential establishments that can satisfy the order details based on location data;
obtaining real-time order preparation times for the order details from the potential establishments;
selecting an optimal establishment from the potential establishments based at least in part on the real-time order preparation times; and
placing the order with the optimal establishment as an online order through an online service.

2. The method of claim 1 further comprising:
monitoring a progression of the order with the optimal establishment;
determining a different establishment from the optimal establishment can fulfill the order before the optimal establishment; and
redirecting the order from the optimal establishment to the different establishment for fulfillment.

3. The method of claim 1 further comprising, providing an identifier for the optimal establishment, an order number for the order, and an estimated fulfillment time to a customer that provided the order details.

4. The method of claim 1, wherein receiving further includes receiving the order details from the online service after a customer provides the order details through the online service.

5. The method of claim 4, wherein receiving further includes identifying the online service as an establishment online service associated with the optimal establishment or an order aggregation online service associated with an order aggregator.

6. The method of claim 5, wherein identifying further includes:
defining a geographic zone from a fulfillment location where the order will be received by a customer associated with the order details; and
identifying the potential establishments as having site locations within the geographic zone based on the location data.

7. The method of claim 6, wherein obtaining further includes:
obtaining available delivery personnel and personnel locations for each of the potential establishments when the order is associated with a delivery to the customer.

8. The method of claim 7, wherein obtaining further includes:
obtaining current traffic conditions between each of the site locations and the fulfillment location.

9. The method of claim 8, wherein selecting further includes:
providing identifiers for each of the potential establishments, the location data, the site locations, the fulfillment location, the current traffic conditions, and the real-time order preparation times as input to a trained machine-learning algorithm; and
receiving as output a ranked listing of the potential establishments sorted based on estimated fulfillment times with a least estimated fulfillment time listed first in the ranked listing.

10. A method, comprising:
identifying order details for an unplaced order by a customer;
obtaining one or more fulfillment locations where a placed order is to be received by the customer;
determining potential establishments that can satisfy the order details and that are within a geographic zone of the one or more fulfillment locations;
acquiring real-time data comprising, estimated order preparation times for the potential establishments and current traffic conditions for the customer to receive a fulfilled order at the one or more fulfillment locations;
processing a machine-learning algorithm with the real-time data and one or more fulfillment locations provided as input and receiving as output from the machine-learning algorithm a ranked listing of the potential establishments;
selecting an optimal establishment from the ranked listing; and
placing the placed order with the order details with the optimal establishment.

11. The method of claim 10 further comprising, redirecting the placed order to a different establishment selected from the ranked listing based on monitoring a progression of the placed order with the optimal establishment.

12. The method of claim 11 further comprising, notifying the customer that the fulfillment location has changed from optimal establishment to the different establishment when the placed order is associated with a pickup order by the customer.

13. The method of claim 10 further comprising, notifying the customer of the optimal establishment, the order details, an expected fulfillment time, and a confirmed fulfillment location.

14. The method of claim 10, wherein obtaining further includes identifying the one or more fulfillment locations as a single fulfillment location associated with a delivery for the fulfilled order to a delivery address associated with the customer.

15. The method of claim 14, wherein obtaining further includes identifying the delivery address as a current customer identified location or a customer-designated address.

16. The method of claim 10, wherein obtaining further includes identifying the one or more fulfillment locations as multiple fulfillment locations, each fulfillment location associated with a potential establishment site location, and the placed order associated with a customer pickup order.

17. The method of claim 10, wherein selecting further includes presenting the ranked listing to the customer and receiving the optimal establishment as a customer selection from the ranked listing.

18. The method of claim 10, wherein selecting further includes automatically selecting the optimal establishment from the ranked listing as a first establishment listed in the ranked listing.

19. A system, comprising:
a server comprising a processor and a non-transitory computer-readable storage medium having executable instructions;
the executable instructions when executed by the processor from the non-transitory computer-readable storage medium cause the processor to perform operations comprising:
identifying potential establishments to satisfy an unplaced order of a customer based on a geographic zone associated with a current location of the customer;
obtaining estimated preparations times for order details of the unplaced order from each of the potential establishments;
obtaining current traffic conditions between the current location of the customer and site locations associated with the potential establishments;
providing the current location of the customer, the estimated preparations times, the current traffic conditions, and the site locations to a machine-learning algorithm;
receiving a ranked listing of the potential establishments as output from the machine-learning algorithm;
selecting an optimal establishment to fulfill the unplaced order from the ranked listing; and
placing a placed order with the order details with the optimal establishment.

20. The system of claim 19, the executable instructions associated with the providing when executed by the processor from the non-transitory computer-readable storage medium is further configured to cause the processor to perform additional operations comprising:
obtaining delivery personnel locations for delivery personnel when the unplaced order is associated with a delivery to the current location of the customer; and
providing the delivery personnel locations as additional input to the machine-learning algorithm.
